(19) United States
(12) Patent Application Publication
(10) Pub. No.: US 2011/0066482 A1
(43) Pub. Date: Mar. 17, 2011

(54) DEVICE AND METHOD FOR REDEEMING AND ISSUING CONSUMER INCENTIVES VIA A COMPUTER NETWORK

(76) Inventor: William A. DePlato, Lenexa, KS (US)

(21) Appl. No.: 12/561,964

(22) Filed: Sep. 17, 2009

(51) Int. Cl. G06Q 30/00; G06K 19/06

(52) U.S. Cl. 705/14.15; 705/14.3; 235/493

(57) ABSTRACT

A discounted coupon card for use by a consumer and methods for using the same are disclosed and described herein. The card comprises two sides and is about the size of a standard credit card. One side of the card includes a sponsoring theme or advertising. The opposite side of the card includes a magnetic strip that includes electro-magnetic data corresponding to the merchants and the purchase incentives and indicia identifying the merchants and purchase incentives or discounts. The magnetic strip is adapted to be read by a magnetic strip reader and the data on the strip can be transmitted to a computer network to provide instant and future discounts for advertised goods or services from a plurality of businesses.

### BACKGROUND OF THE INVENTION

1. Field of the Invention

The present invention relates to an advertising and promotional device and method, more particularly, to a reusable and dynamic coupon card providing instant and future discounts for advertised goods or services from a plurality of businesses.

2. Description of the Prior Art

In the context of marketing or advertising goods or services, manufacturers, service providers, and retailers routinely use tangible, single-use coupons that can be exchanged for a financial discount or rebate when used at the point of sale of a product or service. Although coupons are traditionally distributed through the mail, magazines, or newspapers, the use of printable coupons over the Internet and electronic coupons transmitted to mobile devices are becoming more popular and enjoying greater acceptance by consumers. Manufacturers and retailers have often encouraged the use of coupon books that contain a plurality of coupons for a variety of goods or services. Because discount coupons typically expire within a period of days, weeks, or months after issuance, they are meant to encourage quick purchase decisions by consumers. As an advertising tool, coupons help manufacturers and retailers develop brand loyalty and product awareness for future sales outside the discount period.

One problem with coupons issued by conventional means is that a coupon of particular interest to a consumer is often discovered by accident. The consumer might have to wade through a multitude of printed publications to find a coupon of interest. Another problem with the typical coupon is it is usually limited to a single product or a specific group of products, and once used, is completely exhausted and of limited value as an incentive for future purchases. Because large manufacturers or retailers typically issue coupons, the decision to issue a coupon is usually encumbered by the need to consider sales goals, marketing budgets, strategic objectives, distribution channels, aesthetic appeal, and the like.

Given the state of the art as described above, there is a continuing need for a coupon device that identifies a plurality of discounts from various manufactures, retailers, and service providers and provides additional incentives to consumers for future purchases. There is a further need to provide a method that provides a more nimble means to issue a discount coupon or a set of discount coupons.

The present invention satisfies these needs by providing a reusable, compact, and dynamic coupon card that identifies a plurality of discounted or free products or services from various manufactures, retailers, and/or service providers. The invention as disclosed herein also provides for a coupon card that is customizable in appearance and/or discount offerings by a group or organization interested in selling the card to consumers to generate revenue. The invention herein also can be adapted as a gift card or customer appreciation gift that a retailer can purchase and give to a customer as a token of appreciation.

### BRIEF SUMMARY OF THE INVENTION

In its product aspect, the present invention provides a form of advertisement and a form of promotion. In this aspect, the invention comprises a credit-card-sized coupon card including a plurality of purchase incentives and a magnetizable or magnetic strip. The purchase incentives may include, for example, a plurality of discounted sales offers and/or free products or services from a plurality of businesses. The magnetic strip can be adapted to track the card's use and transmit data to provide additional discounted purchases and/or free incentives.

The magnetic strip on the card may be coded with electro-magnetic data in a format that can be read by a magnetic strip reader or other electronic processor, like a computer or computer network. Proprietary software may also be used to analyze the data on the magnetic strip. So for purposes of example only, when an accepting merchant swipes the magnetic strip of the card through a magnetic strip reader or other device, the data on the card can be transmitted to a computer network adapted to analyze the card's usage. The computer network can be programmed to authorize additional promotional offers, which can be printed on the customer's receipt and/or sent to the customer by electronic means like, for example, electronic mail. As recited herein, a customer is equivalent to a consumer.

The coupon can be sold to consumers by groups or charities, like non-profits, educational institutions, or sports teams as a means of generating revenue for such groups. As an effective means of generating revenue for the organization, group, or charity, the cost of the coupon card can be less than the value of the discounts offered on the card, which provides incentives to both sell and buy the coupon card. The cost of the coupon card can be at least five times less than the value of the discounts offered on the card. Another embodiment of the coupon card includes use as a gift card or customer appreciation gift that a retailer can purchase and give to a customer as a token of appreciation.

Depending on the target audience for the coupon, the group or charity may elect to customize or personalize the coupon card by selecting a certain set of merchant offers to be displayed and offered on the card. A group or organization may also select a particular style, color, or theme for the card that reflects the objectives of the type of group or organization selling the card to generate revenue. The coupon holder can identify the merchant offering the discount or free item by observing the indicia of the source of the discount, like a trademark, slogan, or words.

Another embodiment of the present invention can include a link to an Internet website that lists other opportunities for free or discounted goods and/or services not identified on the card. The use of indicia as the source of the free or discounted products offered on the card and the website also serve to advertise the participating businesses and further establish good will, consumer recognition, and consumer loyalty in the market(s) they serve. An embodiment of the invention may allow the business to advertise its products on the card without charge in exchange for honoring the offered discount and/or providing the free item. The free item may be conditioned or offered unconditionally. A further embodiment includes pairing the coupon card with an advertising brochure. In this embodiment, a consumer can follow the conditions recited in the brochure to obtain free and/or discounted goods or services upon presenting the card to a participating business.

### DESCRIPTION OF THE DRAWINGS

The invention can be better understood by reference to the following drawings, wherein:

FIG. 1 is a generic illustration of the front of the coupon card showing the relative position of certain information.

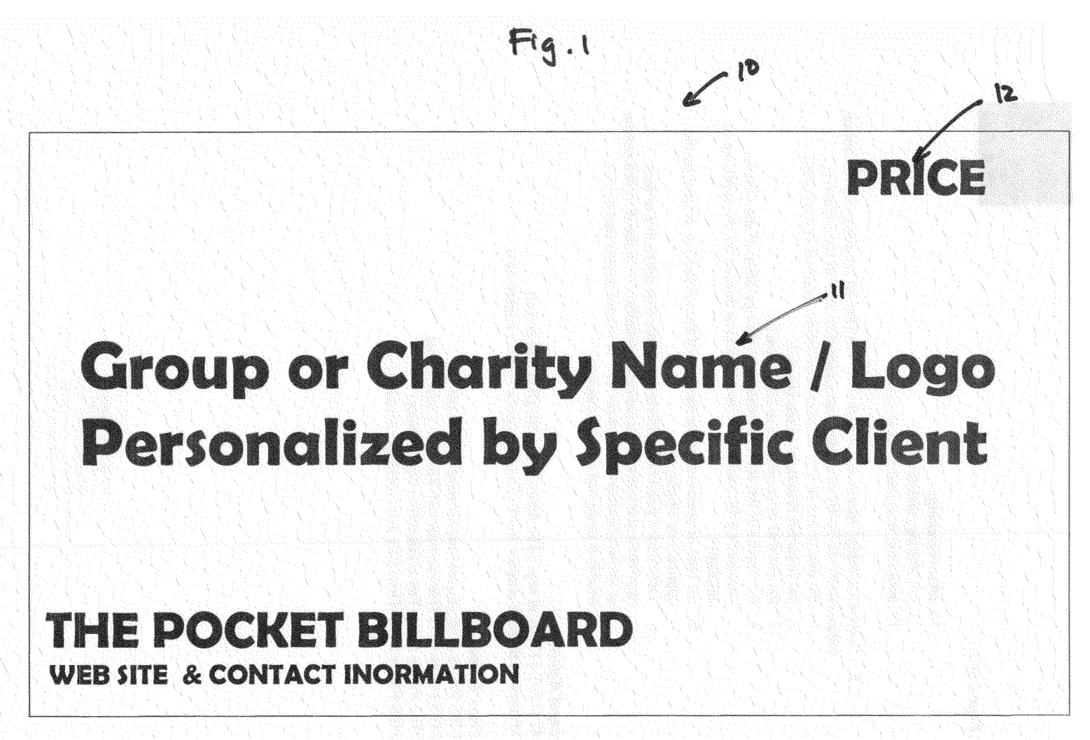

FIG. 2 is a generic illustration of the back of the coupon card showing the relative position of indicia of the source of discounted or free products or services.

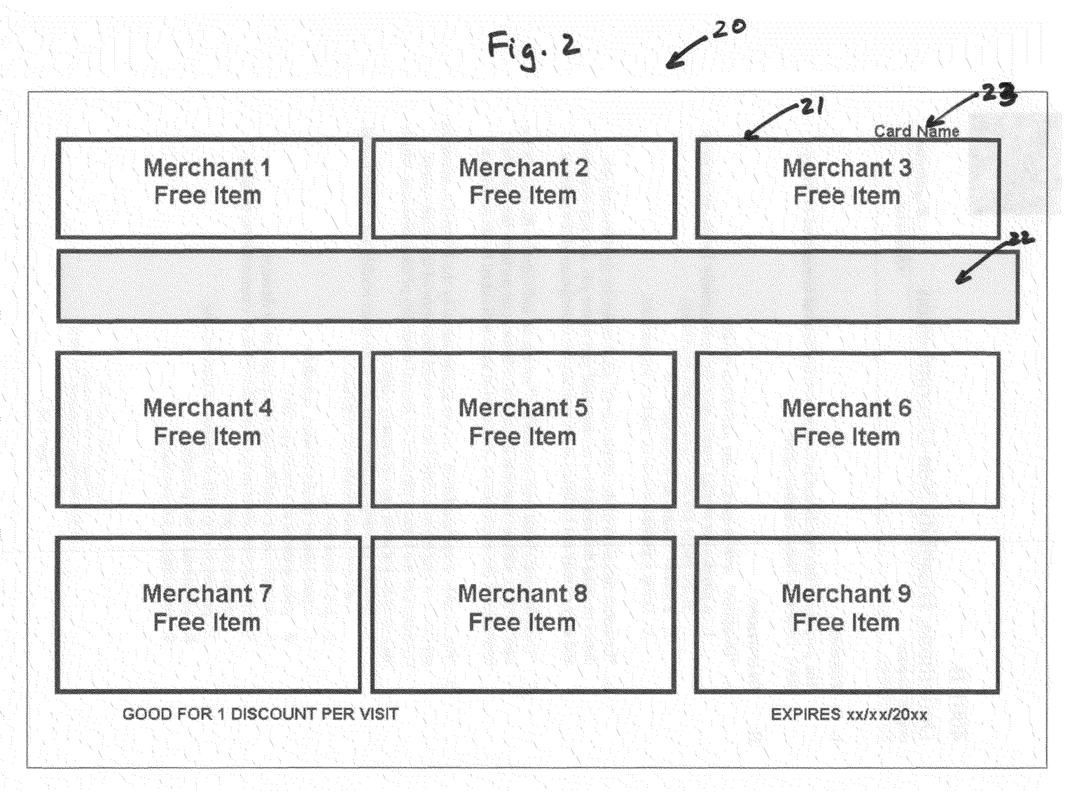

### DETAILED DESCRIPTION

In the following detailed description, reference is made to the accompanying drawings that form a part hereof, and in which are shown by way of illustration specific embodiments or examples. These embodiments may be combined, other embodiments may be utilized, and structural, logical, and procedural changes may be made without departing from the spirit and scope of the present invention. The following detailed description is, therefore, not to be taken in a limiting sense, and the scope of the present invention is defined by the appended claims and their equivalents.

The present invention relates to a form of advertisement and/or promotion. In this embodiment, the invention comprises a credit-card-sized coupon card 10 20 including a plurality of purchase incentives 21, like discounted sales offers, and a magnetizable or magnetic strip 22. By way of non-limiting example only, the plurality of advertised, discounted sales offers 21 are displayed on a side of card 20 using indicia and words that advertise the merchant 21 and the nature of the offered discount 21. Such indicia may include, for example, a trademark or logo of a merchant and a discount offer, like, “10% off your next purchase.” This embodiment includes encoding data on the card's magnetic strip 22. The strip 22 is adapted to electronically store the indicia information identifying the merchants and the nature of the offered discounts. Because the electronically-stored information on the magnetic strip 22 can be accessed and read by devices known in the art to be so adapted, the stored information can be electronically transmitted to a computer or computer network to analyze the card's usage.

In another embodiment, proprietary computer software may be utilized to analyze whether a consumer or user of the card has redeemed an offer and further analyzed to define temporal and geographic information relating to the card's use. In this embodiment, the electronically transmitted information may trigger a feedback response from the computer or computer network that provides the card's user (e.g. a consumer) with additional discounts or even free incentives. The feedback response can include an additional coupon or discount the consumer receives at the point of sale, like, for example, a coupon or discount that is printed directly on the consumer's receipt as a result of the computer or computer network's analysis of the card's use and the marketing/sales objectives of the advertising businesses. In another embodiment, the feedback response to redeeming one or more of the card's offers or discounts can include the transmittal of an additional discount or incentive to a consumer, including the consumer's mailing address, e-mail address, or PDA. In the aforementioned embodiments, the discount or incentive may be represented as a bar code or other well-known symbology that is readable by devices adapted to read such optical representations of data.

In yet another embodiment, the coupon card 10 20 can be sold to consumers by groups or charities, like non-profits, educational institutions, or sports teams, as a means of generating income for such groups. In such an embodiment, the group or charity may sponsor a customized or personalized theme or style 11 23 the group or charity desires to promote. By way of non-limiting example only, the card of the present invention might comprise multiple colors and, for example, a sports theme that reflects the objective of a sponsoring non-profit organization supporting a youth football or soccer league. By way of further example only, the group or charity may elect to customize or personalize the coupon card by selecting a certain set of merchant offers to be displayed and offered on the card. The card also may include indicia that identifies the group or charity selling or promoting the card 11 and be encoded with data authorizing a plurality of discounted or free goods and/or services 21. The coupon holder can identify the merchant offering the discount or free item by observing indicia of the source of the discount, like a trademark, slogan, or words 21. In this embodiment, the value of all the discounts or incentives offered on a card should exceed the cost 12 of the card to the consumer. By way of non-limiting example only, the cumulative value of the card's discounts or incentives can be more than the sales price 12 of the card. More specifically, the cumulative value of the card's discounts or incentives can be at least five times more than the sales price 12 of the card.

In yet a further embodiment, the free item may be conditioned or offered unconditionally. This embodiment may include pairing the coupon card 10 20 with an advertising brochure. The consumer can follow the conditions recited in the brochure to obtain free and/or discounted goods or services. By way of non-limiting example only, the brochure may inform the consumer to present the card at a certain restaurant during a certain time of day to receive a free lunch. Upon satisfying these conditions, the participating restaurant may provide an additional purchase incentive that can be electronically transmitted to the consumer, like, for example, to the consumer's e-mail address.

In an embodiment of a method aspect of the invention, a consumer redeems a purchase incentive by allowing a accepting merchant to swipe the coupon card through a device that is adapted to read the magnetic strip 22 on the card, like, for example, a credit card reader. The data on the card is then transmitted to a computer or computer network including at least one computer processor. The processor is adapted to analyze the data on the card using computer software. The software is adapted to determine the consumer's eligibility for an instant or future purchase incentive. The incentive can be remitted to the consumer instantly on the merchant's receipt or transmitted to the consumer via standard mail or electronically.

It is to be understood that the above description is intended to be illustrative, and not restrictive. For example, the above-described embodiments and variations may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A coupon card for use by a consumer comprising:
a. a first side and an opposite second side;
b. an advertising theme deposed on a first side of the card;
c. a plurality of indicia of purchase incentives deposed on a second side of the card; and
d. a magnetic strip deposed on a second side of the card.

2. The coupon card of claim 1 wherein:
a. the card is about the size of a credit card;
b. the advertising theme includes a sponsored theme;
c. the indicia comprise a plurality of merchant trademarks or logos; and
d. the magnetic strip is encoded with electro-magnetic data corresponding to the plurality of merchants.

3. The coupon card of claim 2 wherein:
a. the indicia further comprise words; and
b. the magnetic strip further includes electro-magnetic data identifying a plurality of purchase incentives of a certain value offered by the merchants.

4. The coupon card of claim 3 wherein the plurality of purchase incentives includes discounted sales offers.

5. The coupon card of claim 3 wherein the plurality of purchase incentives includes free offers.

6. The coupon card of claim 3 wherein the total value of the purchase incentives exceeds a cost of the card to a consumer.

7. The coupon card of claim 5 wherein the card is paired with an advertising brochure that includes information on how to redeem the free offers.

8. The coupon card of claim 6 wherein the total value of the purchase incentives exceeds a cost of the card to a consumer by at least five times.

9. A method of using the coupon card of claim 6 comprising the steps of:
a. swiping the card through a device adapted to read the magnetic strip on the card;
b. transmitting the data stored on the card to at least one computer processor, said processor being adapted with to analyze the data stored on the card using computer software;
c. analyzing the data on the card to determine a consumer's eligibility for an instant or future purchase incentive; and
d. providing the instant or future incentive to the consumer.

10. A method of claim 9, further comprising the steps of:
a. providing the instant purchase incentive on a receipt provided to the consumer.

11. A method of claim 10, further comprising the steps of:
a. providing the future purchase incentive to the consumer electronically.
